(19) United States
(12) Patent Application Publication
(10) Pub. No.: US 2007/0073586 A1
(43) Pub. Date: Mar. 29, 2007

(54) Self-serve ordering system and method with consumer favorites

(75) Inventors: Roger Dev, Durham, NH (US); Aaron Arsenault, Wells, ME (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Nextchoice, Inc., Portsmouth, NH (US)

(21) Appl. No.: 11/513,897

(22) Filed: Aug. 31, 2006

Related U.S. Application Data
(63) Continuation of application No. 11/176,097, filed on Jul. 7, 2005.
(63) Continuation-in-part of application No. 10/620,717, filed on Jul. 16, 2003.
(63) Continuation of application No. 10/620,719, filed on Jul. 16, 2003.
(63) Continuation-in-part of application No. 10/602,203, filed on Jun. 24, 2003.

(51) Int. Cl. G06Q 30/00; G07F 7/00

(52) U.S. Cl. 705/14; 705/27

(57) ABSTRACT

A self-service ordering system including customer favorites includes a mechanism for identifying a customer and for receiving an order from the customer. In the case of a new customer, the received order is stored in memory and correlated with the identified customer identification information. The system uses the order stored in memory and correlated with the consumer identification information to automatically identify items preferred by the customer during future purchases. In the case of a returning customer, the system presents the consumer with one or more “favorites” (previously stored items or lists of items preferred by the customer) for his or her selection without having to access a full menu which can be ordered. The system is further equipped to present a full menu of items which can be ordered by the customer wherein the items identified as preferred or favorites are positioned preferentially in the menu display. The display may include a graphic representation of a receipt tape with at least a torn bottom region as well as a quick order method for allowing a consumer to order using on file payment information.

### CROSS REFERENCE TO RELATED APPLICATIONS

This application is a continuation-in-part of U.S. patent application Ser. Nos. 10/602,203 and 10/620,717. This application also claims priority from U.S. patent application Ser. No. 11/176,097 which claims priority from U.S. patent application Ser. No. 10/602,703 (now U.S. Pat. No. 6,940,393), and U.S. patent application Ser. No. 10/620,719 all fully incorporated herein by reference.

### FIELD OF THE INVENTION

The present invention relates to the field of self-service ordering systems and more specifically, to the field of self-service ordering systems with consumer favorites.

### BACKGROUND OF THE INVENTION

Consumers have begun to interact directly with retailers through a variety of self-service terminals. Examples of these include, but are not limited, to Internet ordering, In-Store kiosks, drive-through kiosks, wireless handheld devices and telephones. Previously, some self-service for consumers has existed such as, for example, banks have provide ATMs, supermarkets provide self-checkout, and e-commerce provides a variety of goods ordered by way of the internet. All of these business interactions are between a consumer and an electronic agent of the retailer. This self-service usage is driven both by the consumer pursuing greater convenience and time-savings, and by advantages to the retail operator such as reduced staffing, enhanced throughput, fewer problems with ordered products and better consumer intelligence.

Although self-service ordering is available to some limited degree, each time a consumer attempts a self-service order, he or she must re-enter an entire order, even if the order is the same as a previous order placed by the consumer. This is frustrating for the consumer as it take time and permits errors by the consumer in ordering his or her desired items.

Thus, an unaddressed need exists to address the above mentioned deficiencies and inadequacies.

### SUMMARY OF THE INVENTION

The preferred embodiments of the present invention provides a self-service ordering system particularly suited for a food service establishment, although this is not a limitation of the present invention. The self-service ordering system includes a mechanism for identifying a consumer. The system is further equipped to receive a food order from the customer. The received food order is stored in memory, wherein the food order is correlated with the consumer identifier if one exists. The system uses the food orders stored in memory and correlated with the consumer to automatically identify food items preferred by the consumer during future purchases. The system is further equipped to present a menu to the consumer wherein the food items preferred are positioned preferentially in the menu.

A self-service ordering system in according with the teachings of the present invention include the ability of the system to provide customer favorites. The system includes a mechanism for identifying a customer and for receiving an order from the customer. In the case of a new customer, the received order is stored in memory and correlated with the identified customer identification information. The system uses the order stored in memory and correlated with the consumer identification information to automatically identify items preferred by the customer during future purchases. In the case of a returning customer, the system presents the consumer with one or more “favorites” (previously stored items or lists of items preferred by the customer) for his or her selection without having to access a full menu of items which can be ordered. The system is further equipped to present a full menu of items which can be ordered by the customer wherein the items identified as preferred or favorites are positioned preferentially in the menu display.

The display may include one or more graphic representations of a receipt tape with at least a torn bottom region as well as a quick order method for allowing a consumer to order an entire list of items from the favorites list or one or more items from one of several preferred lists. The system may also include a method of quickly (one touch) payment of the order using on file payment information.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims and their legal equivalents.

### BRIEF DESCRIPTION OF THE DRAWINGS

These and other features and advantages of the present invention will be better understood by reading the following detailed description, taken together with the drawings wherein:

FIG. 1 is a schematic block diagram of a system which supports the implementation of the present invention;

FIG. 2 is a more detailed schematic block diagram of the service system of FIG. 1;

FIG. 3 is a schematic diagram illustrating the operation of a system embodying the present invention;

FIG. 4 is a schematic illustration of a display screen as part of a system implementing the present invention; and

FIG. 5 is a schematic illustration of a system operation for a system including the present invention.

### DETAILED DESCRIPTION OF THE PREFERRED EMBODIMENTS

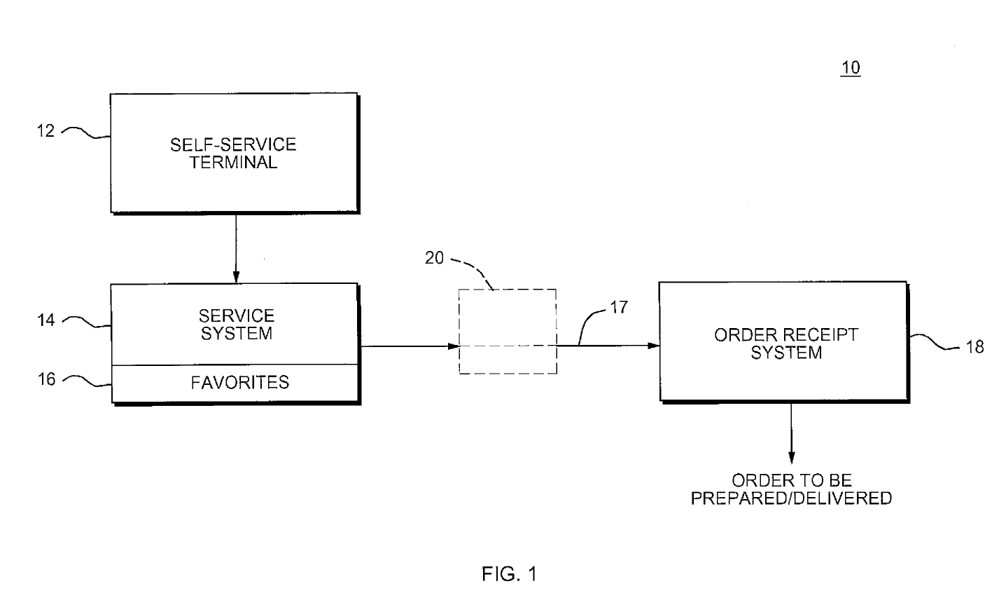

The present invention is described in connection with a food service system 10, FIG. 1, although this is not a limitation of the present invention as the invention may be used in the context of any self-service ordering system. The food service system 10 typically includes a self-service terminal (SST) 12 as described herein, which interfaces with an order service system 14 including a favorites database 16 containing information regarding consumers'previous orders. A self-service terminal 12 may be any workstation, terminal, kiosk, hand-held unit, telephone or other device whereby a user can select and specify items to be ordered and optionally pay for those items. The service system 14 interfaces with the self-service terminal 1, and in conjunction with the “favorites database 16, “remembers” the contents of consumers'previous orders and condenses them into a set of preferred items for each individual consumer as will be explained in more detail below. After the consumer's order is received, the service system 14 either sends the order information 17 directly to the order receiving system 18 for processing or alternatively, may send the order information 17 to an order mapper 20, which in turn translates or converts the order information 17 into the proper format and syntax required for a vendor's order receiving system 18. Such a system and method for order mapping is disclosed in co-pending U.S. patent application Ser. No. 11/471,969 filed Jun. 19, 2006 assigned to the assignee of the present invention and incorporated fully herein by reference.

The consumer begins interaction with the food service system 14 by identifying his or her self through interaction with the self-service terminal 12 including utilization of any of various identification media, including, but not limited to: swiping a credit card; swiping a gift/loyalty card; using a touch screen on internet to log in; and/or using biometric identification (such as a fingerprint identifier). The identification media may include any technology recognized by those skilled in the art presently known or discovered and utilized in the future as applicable for identifying specific individuals.

After logging in, the service system 14 may present the consumer with a view of preferred food items, referred to herein as a “My Favorites” view if the consumer is a repeat customer and a previous order information has been stored. If the consumer is a new customer for this system, the service system 14 will build a favorites list as described below. The “My Favorites” view allows the consumer to choose from one of his or her “favorites” orders previously ordered and/or stored or proceed to access the full menu of available items to be ordered.

The “My Favorites” view is convenient for consumers and presents cost savings to prepared food providers. From the consumer perspective, it limits a need for repeat customers to specify the same item or set of items and accompaniments or toppings during each subsequent visit. The consumer may have a small set of favorite items that he or she likes to order. Depending on the time of day, the weather or the consumer's current mood, they are likely to choose one or more of these “favorite” item(s). The consumer may tend to order the same set of items on each visit. This may vary from visit to visit, based on time of day, or mood, but this consumer, by habit, has his or her order list limited to a small number or sets of items that he or she likes to order. The consumer may come to this store for a very specific purpose and nearly always orders the same set of items. If the system correctly identifies the consumer type and presents the correct choices, the consumer's stress level is reduced, the transaction feels less like a chore, the consumer is more likely to get exactly what he or she wants and moreover, he or she feels cared for and recognized. The service system 14 can even store consumer payment information (like the consumer's preferred credit card number, expiration date, etc.) to avoid having the consumer enter this information each time they place an order.

Speed of service is a benefit felt by both the consumer and the food provider or operator. For the operator, speed of service implies greater throughput through the self-service terminal and through the restaurant. Specific goals related to speed of service include minimized thought time, minimized number of actions (e.g. touches) the consumer must complete, and minimized wait time such as payment authorization and order submittal.

The service system 14 typically makes use of an identification medium (IM) to identify the consumer. Any means of establishing a consumer's identity to the service system 14 can be utilized as an identification medium. Examples include UserId/Password entry, Credit Card, Debit Card, Gift Card, Loyalty Card, Radio-Frequency Identification (RFID) devices and Biometric methods such as fingerprint, palm-print, retinal-scan, voice-print or facial identification.

Identification mediums may be correlated either explicitly or implicitly. Explicit correlation occurs when a consumer chooses a function that allows management of her profile (e.g., Edit Profile). This allows any number of identification medium accounts to be specified within the profile as might be the case if a consumer has multiple credit or debit cards that he or she uses along with perhaps a radio-frequency identification device. Explicit correlation may also allow modifications of preferred food items and the algorithms that determine preferred food items.

Implicit correlation occurs when a consumer employs one of multiple identification mediums associated with the consumer during a single session. For example, the consumer begins a session by swiping a loyalty card, then chooses to pay using a separate credit card. These two cards should now be correlated and future use of the credit card can access the consumer's loyalty information. Any of a consumer's identification mediums may be correlated, if multiple identification mediums are tracked, although correlation of multiple identification mediums is not required and, in some instances, may be undesirable. Further, if an identification medium is correlated with a loyalty card, loyalty card benefits may be made available to the consumer through the identification medium. See U.S. patent application Ser. No. 10/620,719 incorporated fully herein by reference for examples of customer loyalty card's and a system fee utilizing and managing such cards and self-service terminals.

A preferred food item may not appear on the “My Favorites” view if the item has been discontinued, is out of stock or is otherwise unavailable. Alternatively, the unavailable preferred food item may appear on the “My Favorites” view with a brief explanation that the preferred food item is unavailable and may perhaps include a suggestion as to a similar substitute item that the consumer may wish to select.

Preferred food orders may be presented on the “My Favorites” view. Preferred orders include a combination of food items preferred by the consumer. Multiple preferred food orders may be presented on the “My Favorites” view if the food service system identifies multiple, different food orders preferred by the consumer. Preferred food orders may be developed on the basis of repeated ordering of the same or a similar combination of food items. Further, unavailability of a food item from a preferred food order will not diminish a ranking of that food order preference during future purchases.

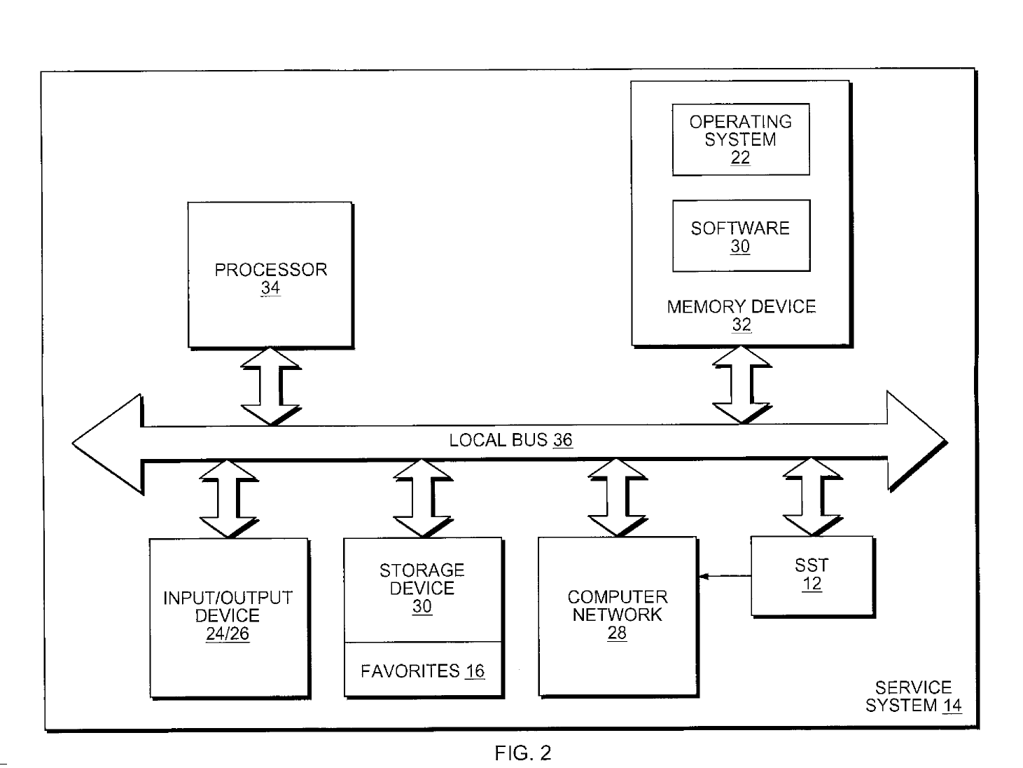

FIG. 2 illustrates an exemplary service system 14 which is comprised of a processor 34 under control of an operating system 22 and operational software 30. A memory device 32 may be provided to support the operation of the software 30 and the operating system 22. The service Sys. 14 may further include an input output device 24, 26 such as a keyboard and monitor as well as a storage device 30, such as a disk drive, long-term storage memory or the like which typically contains the favorites database 16. The service Sys. 14 may also include a computer network interface 28 which provides access to the service Sys. 14 from a remote device such as self-service terminal 12. All of the elements of service Sys. 14 are typically coupled by a local data bus 36. As is well known to those killed in the art, a service system 14 may be assembled in many different configurations without departing from the scope of the present invention.

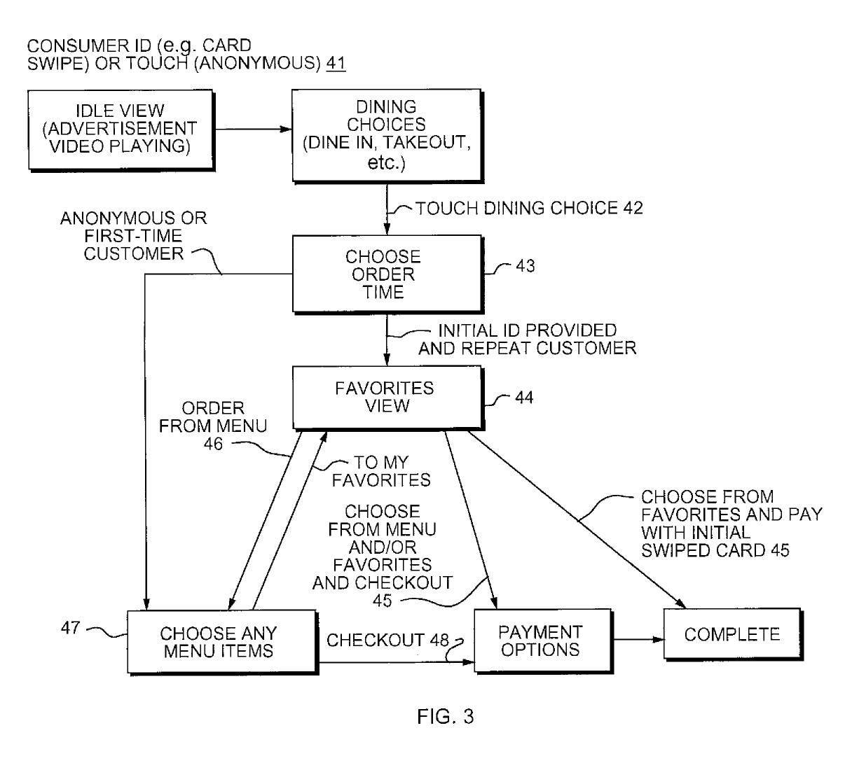

FIG. 3 is a flow diagram of a first exemplary embodiment of the self-service ordering system with favorites according to the present invention. A consumer first identifies him or her self by presenting identification medium or touches the screen to start either anonymously or as a first-time user, act 41. A consumer next selects a dining choice (e.g., Eat In, Dine Out), act 42. This act may be skipped if the dining choice is not applicable.

If the purchase is being made through the Internet or otherwise from a remote location, the consumer selects delivery or availability time for the order, act 43, otherwise this act may be skipped. If a customer originally presented identification and has previous purchases and “favorites” information stored, his or her “favorites” information is retrieved using the customer identification information and the “My Favorites” view is presented, act 44. If a consumer has not had any previous contact with the service system or if a consumer logs on anonymously, a consumer is presented with and allowed to order from the full menu, act 46. A consumer can then choose a food item (by touching the name of the item on a touch screen, for example or by any other means depending on the type of self-service terminal being used) and/or a food order (by touching the ALL button) from the “My Favorites” view. If ordering is completed, the consumer may move forward with purchasing and check out, act 48. A consumer may also choose some favorites and then “Order from Menu” to choose alternate items or items additional to those presented in the “favorites” view. Traditional menu selection is presented to anonymous users, first time identified users and anyone who chooses “Order from Menu”, acts 46 and 47.

Any supported payment option may be chosen if coming from “Checkout” or “Pay with other method”.

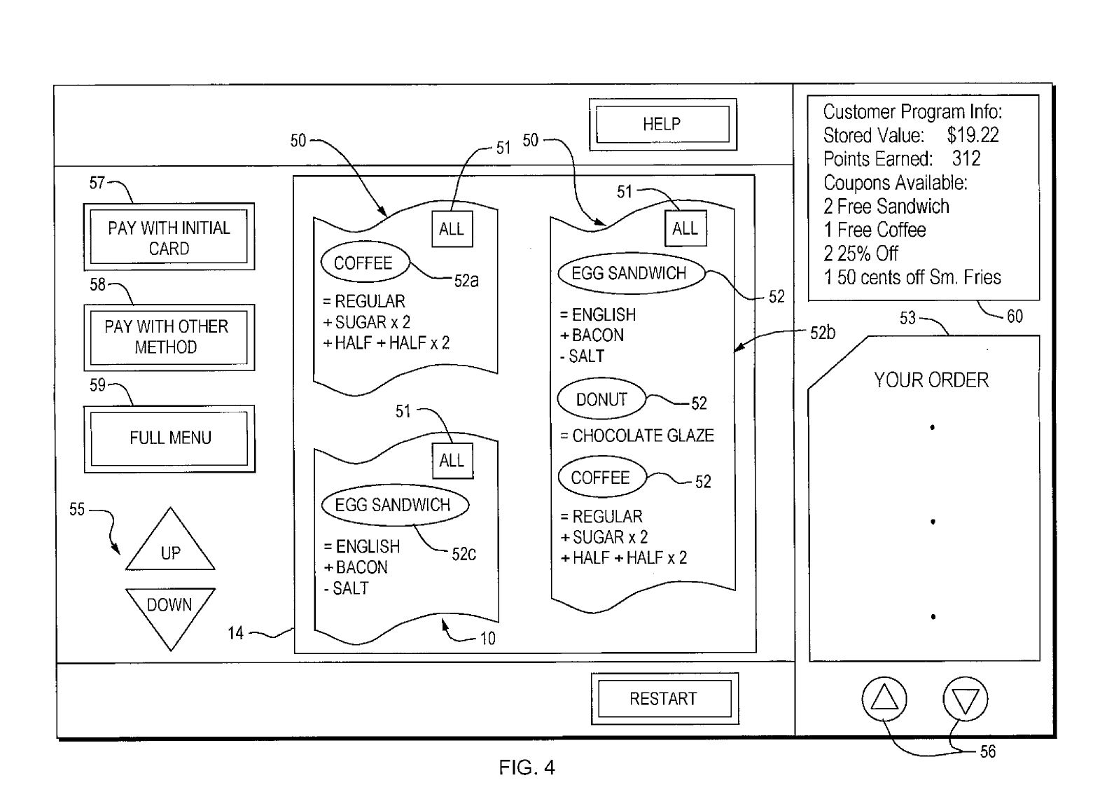

FIG. 4 is a sample screen image in accordance with the first exemplary embodiment of the invention. The screen image is one example of a possible image of the “My Favorites” view displayed on a self-service terminal. The “My Favorites” view presents the current consumer's preferred food order fragments and allows the consumer to add those food order fragments or food items from those fragments to his or her current food order. It also allows the consumer to proceed to payment or view the full menu. As shown in FIG. 4, “My Favorites” view may include order fragments 50 that may be visually presented as sections of receipt tape, for example, to aid in consumer recognition of their context. Pressing the “All” button 51 on a receipt fragment 10 may cause all of the items on that receipt fragment to be added to the current order while pressing an individual item 52 on a receipt fragment 50 may cause that item to be added to the current order.

A mock receipt tape 53 may be provided on the right to identify food orders and/or food items added to the current order. Preferred order fragments 52 may be, for instance, placed in the Favorites view in a priority order, such as: a first order fragment 52ais placed at the top of the left column; a second order fragment 52bis placed at the top of the right column while subsequent order fragments (52c for example) are placed in the column with the shortest contents.

Up and down arrows 55 cause the view to scroll and may allow the consumer to view long fragments or lower priority fragments. Up and down arrows 56 may be provided to allow scrolling up and down of the order receipt tape 53 to be able to view the full order. The “Pay with Initial Card” button 57 may cause the order to be submitted and paid with the already swiped identification medium while a “Pay with Other Method” button 58 may allow the consumer to choose another payment method such as Cash or a different Credit, Debit, or Gift Card.

The “Full Menu” button 59 presents the full menu while continuing to show the receipt tape 53, allowing the consumer to combine items from Favorites and the Full menu into the order. The “Customer Program Info” box 60 (top right) may be provided to display various information about the status of this consumer's Customer Program participation (if provided) such as the current amount of stored value, points earned and reward or electronic coupon information. Touching this box may present the user with a set of Customer Program features such as extended balances, the ability to purchase additional stored value, the ability to redeem rewards, and the ability to modify account information.

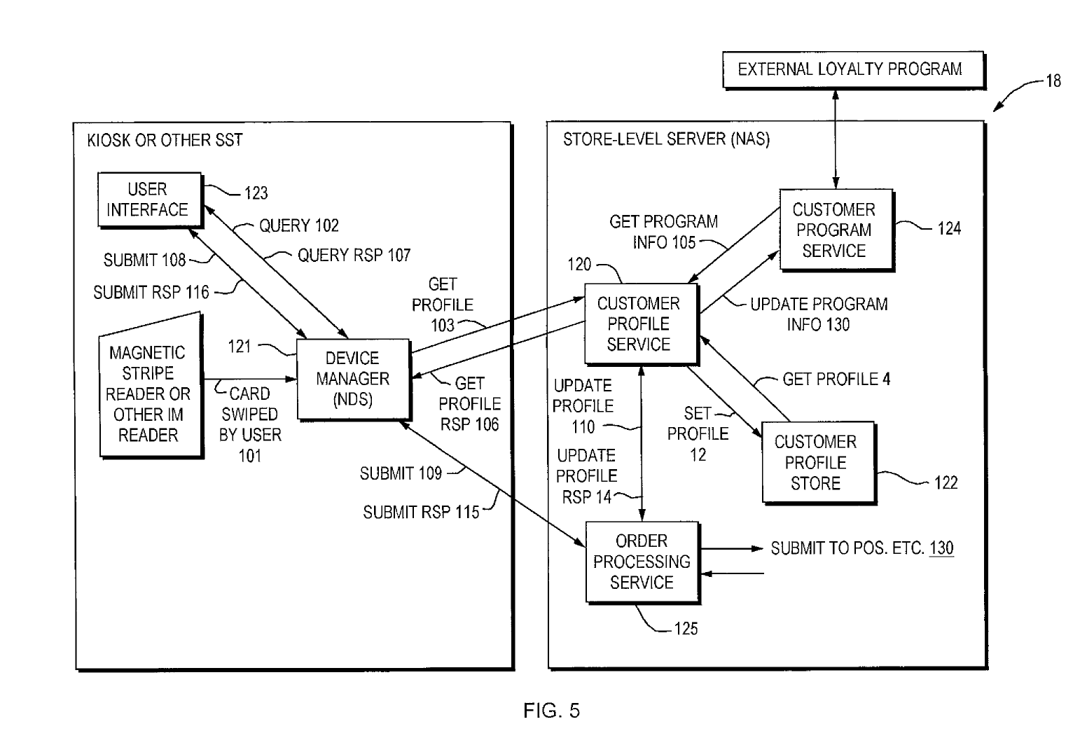

FIG. 5 is a flow diagram illustrating an exemplary system process for a self-service system with favorites in accordance with a first exemplary embodiment of the invention. The process starts when a user presents an identification medium (IM) (e.g., swipes a card), act 101. The Device Manager 121 (NDS) receives the IM information.

A user interface periodically polls the NDS 121 for a status change by sending a Query message, act 102. This returns an IDLE status until an IM is presented, at which point the NDS 121 proceeds. The NDS 121 sends a getprofile message, act 103, to the Customer Profile Service 120 in the order receiving system 18 (hereinafter NAS) which is typically a store or location level server. The Customer Profile Service 120 receives the request and reads the customer profile using the Customer Profile Store module 122. If the customer profile does not yet exist, a new one will be created. The customer profile service may request Customer Program Information (e.g., Loyalty Program) from the Customer Program Service 124. If any matching Customer Program Information was found, based on the IM provided, or any implicitly or explicitly correlated IMs, this information may be overlaid upon the profile from the Customer Profile Store 124 to create a single customer profile with the combined set of information.

The Customer Profile Service 124 will then typically send a getprofile Response 106 to the NDS 121. The getprofile Response 106 will contain the consumer's single customer profile with the combined set of information. The NDS 121 may then send a Query Response 107 to the User Interface 123. The Query Response indicates that the transaction is now active and contains the consumer's single customer profile information including the presFavorites field. The User Interface 123 starts a transaction, and formats the “My Favorites” view for the consumer.

When the user has finished ordering and selected a payment option, the user interface 123 will send a Submit message 108 to the NDS[This could be called the “Device-level Server”]. The NDS 121 forwards the Submit message 109 to the Order Processing Service 125 of the NAS 18. The Order Processing Service 125 then sends the order 130 to a food preparer to prepare the order. The order may be sent using a Point Of Sale Integration Service and other subsystems not pictured here but well know to those skilled in the art.

The Order Processing Service 125 will then run the Favorites Computation Algorithm (described below) based on the contents of the order and will also update the consumer profile information based on other aspects of the transaction such as Stored Value Consumed, Additional Stored Value purchase, Points earned, etc. It then forwards the modified profile act 110 to the Customer Profile Service for updating. The Customer Profile Service saves the modified profile using the Customer Profile Store module 120. Optionally, the Customer Profile Service 120 may update any Customer Program Information that has changed using the Customer Program Service.

The Customer Profile Service 120 sends a updateprofile Response 114 to the Order Processing Service 125. The Order Processing Service 125 then sends a Submit Response 115 to the NDS 121. The NDS 121 then sends a Submit Response 116 to the User Interface 123. The User Interface 123, at this point, indicates to the user that the transaction was completed successfully and ends the session.

A loyalty program is a program provided by or through the operator of the self-service terminal 12 or the order receiving system 18 that provides a consumer an account with special features such as: private debit accounts, accumulation of points leading to rewards, or granting of rewards for certain behaviors or combination of behaviors (e.g., visiting twice in one week, visiting during non-peak hours, etc.). Loyalty programs are typically tied to at least one IM for a given consumer. This IM is referred to as the Loyalty IM. These programs go by various names in the industry such as: gift cards, loyalty cards, customer affinity programs, etc. The customer profile is a persistent set of information that is maintained about a consumer and his or her interaction with the service system or other aspects of the retail operation. These profiles may be ubiquitous (i.e. accessible from any store in a chain or across chains) or may be local (i.e. only accessible from a single store.) Ubiquitous profiles may be stored on a central server or may be stored across a plurality of servers using any of various data distribution methods.

Favorites information is typically stored in the customer profile record by means of the customer profile service 120 and the customer profile store module. As an example, four (4) profile fields are used to store favorites information:
a. Sort Favorites—This field contains a compiled version of each order fragment, indexed by rank. The order fragments are compiled into a form such that any two orders considered equivalent (see below) will produce the same compiled form. This thereby allows recognition of equivalent order fragments. It is persisted to storage.
b. Ordered Favorites —This field contains a list of order fragments indexed by rank, but not sorted. It uses item numbers to identify the items in the order fragment. The items in the order fragment are listed in the same order and using the same quantity specification as used by the consumer when placing the order. This field is also persisted to storage.
c. Presented Favorites —This field contains a list of validated favorites (output of the Favorites Validation Process below). This is used for communication between the NAS 18 and the User Interface 123 and should not be persisted to disk as it will be recreated on the next read.
d.Order Factor —This is the current value of the order factor as defined in the favorites computation process below. It is persisted.

One exemplary format for the sortFavorites, ordFavorites and presFavorites fields is defined below:

Sort Favorites Format

| “{<rank1>:‘<compiledFragment1>’,<rank2>:‘<compiledFrag | |
|---|---|
| ment2>’, ...}” | |
| <compiledFragmentN> := | “<itemSpec1>˜˜<itemSpec2>˜˜ |
| ...” | |
| <itemSpecN> := “<itemName>” or “#<itemNumber>” | |

To achieve non-variance of the compiled form for different equivalent order fragments, the following transformations are performed:
Quantities are extended to achieve quantity designation independence as follows:
   For each item:
      For quantity:
         Emit <itemspec>
         For each item option
         For option quantity
         Emit <optionspec>
The resulting list of itemspecs is sorted (text sort) to achieve sequence independence.

Ordered Favorites Format

“{<rank1>:‘<orderFragment1’>,<rank2>:‘<orderFragment2’
, ...}”
<orderFragmentN> :=
“<itemDescript1>˜˜<itemDescript2>˜˜ ...}”
<itemDescriptN> :=

“<itemSpec>;;<itemQuantity>;;<itemGroup>;;<itemPrice

>”
<itemSpec> := “<itemName>” or “#<itemNumber>”

Presented Favorites Format

| “<orderItems1>,<orderItems2>, ...” | |
|---|---|
| <orderItemsN> := | “<itemSpec1>;;<itemPrice1>˜˜ |

<itemSpec2>;;<itemPrice2>˜˜

...”
<itemSpecN> := “<itemName>” or
“<itemName>##<itemQuantity>”

or “<itemName>@@<groupName>” or
“<itemName >@@<groupName>##<itemQuantity>”

Order Items are sorted by order of rank.

The favorites computation process may be run by an order processing service 125 during a submission process. The favorites computation process runs after the order has been successfully sent to the POS or queued for later delivery and before the active consumer profile is updated and flushed to disk. The favorites computation process maintains an effective list of preferred food items and preferred food orders, taking into consideration both frequency and currency of each order fragment. It also keeps the list of preferred food items and preferred food orders from becoming too large and unwieldy.

An exemplary algorithm for maintaining the list is provided:

Algorithm

Let X be an order fragment represented by a string

Let agingFactor be a real number >=1.0

Let purgeFactor be a real number <=1.0

Let U represent a user account

Computing Ranking of orderfragments:
When a new profile is created:
   U.orderFactor=1
When a new orderFragment(X) is added for user(U):
   U.orderFactor=U.orderFactor*agingFactor
   Rank(X, U)=U.orderFactor
When an orderFragment(X) is equivalent to an existing orderFragment(Y):
   U.orderFactor =U.orderFactor*agingFactor
   Rank(Y,U)=Rank(Y,U)+U.orderFactor

Purging Non-relevant items:
For each item (X):
Purgeable(X,U)=Rank(X,U)/U.orderFactor<purgeFactor
Any order fragments for which Purgeable is TRUE will be deleted.

A favorites validation process is run by the customer profile service 120 during getProfile act 103, as shown in FIG. 5. This process transforms the ordered version of the customer's favorites to a presented favorites version by performing a validation on the ordered version. Below is an exemplary favorites validation process algorithm:

Favorites Validation Process Algorithm
For each item in each order fragment of ordFavorites, in inverse rank sequence:
   Verify that the item still exists and is active using the Menu Service. If the item is active, add it to the presFavorites list. If the item did not exist in the Menu Service, remove the item from ordFavorites and sortFavorites.
   Lookup the current price of the item (including its options) using the Menu Service. Set the current price for the item in presFavorites
If ordFavorites was modified, revalidate it
   Verify that there are no equivalent order fragments (could have been created by deleting an item from an order fragment). If an equivalent order fragment was found, remove it from both ordFavorites and sortFavorites.
   If ordFavorites or sortFavorites was modified, commit the changes back to disk.

The user interface validation process is run by the user interface 123 after receiving a profile containing presented favorites and the disabled items list. The disabled items list is maintained by the menu service (not shown) in the NAS 18 and presents items that are unavailable at the time the order is requested based on factors such as Time of Day; Day of Week; Item availability as determined by an external POS system; and capabilities of the current store

An exemplary user interface validation process which is typically a validation based on current conditions. The first validation process permanently removes items that are no longer valid. This validation process, which temporarily eliminates items that are not being served at this time or are temporarily out of stock, involves:

Algorithm

For each item in each order fragment of presented Favorites:
   If item is in disableditems list:
      Remove it from order fragment
If any items were removed:
   Revalidate all order fragments and remove equivalent fragments (could have been created by removing items).

A profile merge process is employed whenever two customer profiles are implicitly or explicitly merged. This process causes the first profile to be modified such that it embodies the favorites of both profiles.

Algorithm

For each item X in profile2.sortFavorites:
   If item is in profilel.sortFavorites:
      Set item's rank in both sortFavorites and ordFavorites of profilel to: rank(X, profilel)+rank(X, profile2)*profilel.orderFactor/profile2. orderFactor
   If item is not in profilel.sortFavorites:
      Add item to profilel.sortFavorites and profilel.ordFavorites
      Set item's rank in both sortFavorites and ordFavorites of profilel to: rank(X, profile2)*profilel.orderFactor/profile2. orderFactor

Accordingly, the present invention features a novel self service ordering system with favorites in which customer favored information can be created, stored and updated. The customer favored information is retrieved automatically when a customer logs into the self service ordering system thereby presenting the customer with a list of items or groups of items that he or she has previously ordered including any specific treatments, toppings, condiments, variations or the like which the consumer prefers. The customer can quickly, conveniently and without error select from this list of his or her favorites; key and add to their order from a main menu of the items which can be ordered; or can order completely from the main menu. Payment for the ordered items may then be effectuated using either information stored in the customer's profile or a new payment method directed by the customer at the time of ordering.

It should be emphasized that the above-described embodiments of the present invention are merely possible examples of implementations, simply set forth for a clear understanding of the principles of the invention. In addition, it should be further emphasized that the present invention has been explained in the context of a self-service food ordering system although this is not a limitation of the present invention as the invention may be utilized in any type of product or service ordering system.

Many variations and modifications may be made to the above-described embodiment of the invention without departing substantially from the spirit and principles of the invention. All such modifications and variations are intended to be included herein within the scope of this disclosure and the present invention and protected by the allowed claims and their legal equivalents.

We claim:

1. A self-service ordering system comprising:
a self-service ordering device, configured for receiving at least consumer identification information, for allowing a consumer to identify him or her self to the self-service ordering system, said self service ordering device including means for receiving said identification information from the consumer, said self-service ordering device further including means for receiving an order from the consumer;
means, responsive to said received consumer identification information, configured for identifying a consumer;
means, responsive to said received consumer order, for storing the received order in memory, and for correlating the received order with the identified consumer;
means, responsive to said received consumer identification information and to a previously stored received consumer order, configured for automatically identifying items preferred by the identified consumer based on information about the consumer's previous orders stored in memory and correlated with the consumer; and
means, responsive to identified items preferred by the identified consumer, configured for presenting a menu of items which can be ordered by the consumer, wherein the consumer's preferred items are positioned preferentially in a presentation of possible menu items which can be ordered by the consumer.

2. The self service ordering system of claim 1, wherein the means for identifying a consumer further comprises at least one of the group consisting of a biometric device, a consumer-entered login, a credit card, a loyalty card, and an identification through a computer network.

3. The self service ordering system of claim 1, wherein the means for identifying items preferred by a consumer further comprises a sorted list of orders received from the identified consumer and stored in memory, and wherein the sorted list of orders is sorted based upon the frequency of an item being ordered.

4. The self-service ordering system of claim 3, further comprising means for accessing the sorted list using a computer network, said means for accessing the sorted list configured for allowing a consumer to customize their identified preferred items.

5. The self-service ordering system of claim 1, wherein said order includes a food order and further comprising means for allowing said identified consumer to choose an entire past food order or one or more items from an entire past food order.

6. The self-service ordering system of claim 1, wherein said means for automatically identifying items preferred by the identified consumer based on information about the consumer's previous orders stored in memory and correlated with the consumer is responsive to the frequency in which items are ordered and the currentness of the previous order(s).

7. The self-service ordering system of claim 1, wherein said means for storing the received order in memory, and for correlating the received order with the identified consumer purges stored received order information for an identified consumer if an item has not been ordered for a predetermined amount of time.

8. The self-service ordering system of claim 1, wherein said means for storing the received order in memory, and for correlating the received order with the identified consumer recognizes and condenses generally similar orders which may differ based on a sequence of ordered items and/or a method used to specify the quantities of ordered items.

9. The self-service ordering system of claim 1, wherein said means configured for presenting a menu of items which can he ordered to the consumer, is also responsive to ordered item availability and time of preparation or delivery of the ordered item for presenting a modified list of menu items including both preferred items and general menu items.

10. The self-service ordering system of claim 1, wherein said self-service ordering system stores one or more consumer specific details along with said consumer identification information, wherein said self-service ordering system stores more than one said consumer identification information for a specific consumer, and wherein said self-service ordering system is configured to associate said one or more consumer specific details with each said more than one consumer identification information belonging to a specific consumer.

11. The self-service ordering system of claim 10, wherein said means, responsive to said received consumer identification information and to a previously stored received customer order, configured for automatically identifying items preferred by the identified consumer based on information about the consumer's previous orders stored in memory and correlated with the identified consumer is responsive to each said more than one consumer identification information belonging to a specific consumer, for identifying items preferred by the identified consumer.

12. The self-service ordering system of claim 1, wherein a consumer may place an order using three transaction actions comprising the acts of:
entering consumer identification information;
selecting an order from a presented list of favorite items; and
instructing the self-service system to pay for the ordered items using pre-existing payment details previously on file in the self-service ordering system.

13. The self-service ordering system of claim 1, wherein said self-service ordering system allows a consumer to start a transaction using a first consumer identification information to place an order and a second consumer identification information to pay for the order, and wherein said self-service ordering system links said first and second consumer identification information with said consumer identified items preferred by the identified consumer.

14. The self-service ordering system of claim 1 wherein said means configured for presenting a menu of items which can be ordered by the consumer presents said menu items including a graphical representation including list of items positioned on a simulated paper tape receipt.

15. The self-service ordering system of claim 18 wherein said graphical representation includes a simulated paper tape receipt graphical representation having at least a torn bottom edge appearance.

16. The self-service ordering system of claim 14 wherein said means configured for presenting a menu of items which can be ordered by the consumer presents a plurality of said graphical representations, each said graphical representation including a list of items positioned on a simulated paper tape receipt.

17. The self-service ordering system of claim 14 further including means configured for allowing a consumer to order selected items from said menu of items which can be ordered.

18. The self-service ordering system of claim 16 further including means configured for allowing a consumer to order select items from said menu of items, and wherein said means for allowing a consumer to order select items from said menu of items allows said consumer to order menu items from several lists of displayed menu items.

19. The self-service ordering system of claim 18 wherein said means configured for allowing a consumer to order select items from said menu of items includes means for allowing a consumer to purchase all items on one list of displayed menu items.

20. The self-service ordering system of claim 18 wherein said means configured for allowing a consumer to order select items from said menu of items includes means for allowing a consumer to purchase one or more items from more than one list of displayed menu items.

21. The self-service ordering system of claim 17 further including one touch ordering means, responsive to said means for allowing a consumer to order selected items from said menu of items which can be ordered, for paying for all selected menu items using previously stored consumer payment information.

22. The self-service ordering system of claim 1 further including means configured for allowing a consumer to order selected items from said menu of items which can be ordered, and further including one touch ordering means, responsive to said means for allowing a consumer to order selected items from said menu of items which can be ordered, for paying for all selected menu items using previously stored consumer payment information.

23. A self-service food ordering system comprising:
a self-service ordering device, configured for receiving at least consumer identification information, for allowing a consumer to identify him or her self to the self-service food ordering system, said self service ordering device including means for receiving said identification information from the consumer, said self-service ordering device further including means for receiving a food order from the consumer;
means, responsive to said received consumer identification information, configured for identifying a consumer;
means, responsive to said received consumer food order, for storing the received food order in memory, and for correlating the received food order with the identified consumer;
means, responsive to said received consumer identification information and to a previously stored received consumer food order, configured for automatically identifying food items preferred by the identified consumer based on information about the consumer's previous food orders stored in memory and correlated with the consumer; and
means, responsive to identified food items preferred by the identified consumer, configured for presenting a menu of food items which can be ordered by the consumer, wherein the consumer's preferred food items are positioned preferentially in a presentation of possible food menu items which can be ordered by the consumer.

24. The self-service ordering system of claim 23 wherein said means configured for presenting a menu of food items which can be ordered by the consumer, wherein the consumer's preferred food items are positioned preferentially in a presentation of possible menu of food items which can be ordered by the consumer, said presentation of food menu items including a graphical representation including at least one list of food items positioned on a simulated paper tape receipt.

25. The self-service ordering system of claim 24 wherein said graphical representation includes a simulated paper tape receipt graphical representation having at least a torn bottom edge appearance.

26. The self-service ordering system of claim 24 wherein said means configured for presenting a menu of food items which can be ordered by the consumer presents a plurality of said graphical representations, each said graphical representation including a list of food items positioned on a simulated paper tape receipt.

27. The self-service ordering system of claim 24 further including means configured for allowing a consumer to order selected food items from said menu of items which can be ordered.

28. The self-service ordering system of claim 26 further including means configured for allowing a consumer to order selected food items from said menu of food items, and wherein said means for allowing a consumer to order selected food items from said menu of food items allows said consumer to order food menu items from several lists of displayed food menu items.

29. The self-service ordering system of claim 28 wherein said means configured for allowing a consumer to order selected food items from said menu of food items includes means for allowing a consumer to purchase all items on one list of displayed menu items.

30. The self-service ordering system of claim 28 wherein said means configured for allowing a consumer to order selected food items from said menu of food items includes means for allowing a consumer to purchase one or more food items from more than one list of displayed food menu items.

31. The self-service ordering system of claim 27 further including one touch ordering means, responsive to said means for allowing a consumer to order selected food items from said menu of food items which can be ordered, for paying for all selected food menu items using previously stored consumer payment information.

32. The self-service ordering system of claim 23 further including means configured for allowing a consumer to order selected food items from said menu of food items which can be ordered, and further including one touch ordering means, responsive to said means for allowing a consumer to order selected food items from said menu of food items which can be ordered, for paying for all selected food menu items using previously stored consumer payment information.

33. A self-service ordering system comprising:
a self-service ordering device, configured for receiving at least consumer identification information, for allowing a consumer to identify him or her self to the self-service ordering system, said self service ordering device configured for receiving said identification information from the consumer, said self-service ordering device further configured for receiving an order from the consumer;
a consumer identification module, responsive to said received consumer identification information, configured for identifying a consumer;
a storage and correlation module, responsive to said received consumer order, for storing the received order in memory, and for correlating the received order with the identified consumer;
a consumer favorites module, responsive to said received consumer identification information and to a previously stored received consumer order, configured for automatically identifying items preferred by the identified consumer based on information about the consumer's previous orders stored in memory and correlated with the consumer; and
a favorites presentation module, responsive to identified items preferred by the identified consumer, configured for presenting a menu of items which can be ordered by the consumer, wherein the consumer's preferred items are positioned preferentially in a presentation of possible menu items which can be ordered by the consumer.

34. The self-service ordering system of claim 33 wherein said consumer identification module, said storage and correlation module, said consumer favorites module, and said favorites presentation module are implemented using computer software.

35. The self-service ordering system of claim 33 wherein said self-service ordering device is selected from the group consisting of a telephone, a computer and a self service ordering terminal.

36. The self-service ordering system of claim 33 wherein said favorites presentation module presents said menu items including a graphical representation including list of items positioned on a simulated paper tape receipt.

37. The self-service ordering system of claim 36 wherein said graphical representation includes a simulated paper tape receipt graphical representation having at least a torn bottom edge appearance.

38. The self-service ordering system of claim 36 wherein said favorites presentation module presents a plurality of said graphical representations, each said graphical representation including a list of items positioned on a simulated paper tape receipt.

39. The self-service ordering system of claim 36 further including an ordering device, for allowing a consumer to order selected items from said menu of items which can be ordered.

40. The self-service ordering system of claim 38 further including a one touch ordering device, for allowing a consumer to order selected items from said menu of items, and wherein said one touch ordering device allows said consumer to order menu items from several lists of displayed menu items.

41. The self-service ordering system of claim 40 wherein said one touch ordering device allows a consumer to purchase all items on one list of displayed menu items.

42. The self-service ordering system of claim 40 wherein said one touch ordering device allows a consumer to purchase one or more items from more than one list of displayed menu items.

43. The self-service ordering system of claim 39 further including a payment module, responsive to said ordering device, for paying for all selected menu items using previously stored consumer payment information.

44. The self-service ordering system of claim 33 further including an ordering device, configured for allowing a consumer to order selected items from said menu of items which can be ordered, and further including a one touch payment module, responsive to said ordering device, for paying for all selected menu items using previously stored consumer payment information.

45. The self-service ordering system of claim 1 wherein said self-service ordering device is selected from the group consisting of a telephone, a computer and a self service ordering terminal.

46. The self-service ordering system of claim 23 wherein said self-service ordering device is selected from the group consisting of a telephone, a computer and a self service ordering terminal.

47. The self-service ordering system of claim 1, further comprising an output readily accessible by an employee of an order fulfillment organization, wherein the employee may receive the order and begin preparing the order.

48. The self-service ordering system of claim 47, wherein said order includes a food order, and wherein said order fulfillment organization includes a food service organization.

49. The self-service ordering system of claim 1, further comprising means for offering the consumer a discount on a purchase based on the identified ordered items preferred by the consumer.

50. The self-service ordering system of claim 1, wherein said order includes a food order and further comprising means for grouping said consumer preferred food items in the menu presented to present a preferred meal comprising a number of food items preferred by the consumer.
